(19) United States
(12) Patent Application Publication
(10) Pub. No.: US 2006/0198923 A1
(43) Pub. Date: Sep. 7, 2006

(54) Feeding mechanism for injection-molding machine

(76) Inventors: I-Sheng Liu, Taichung (TW); Chih-Hung Liu, Taichung (TW)

Correspondence Address: BACON & THOMAS, PLLC, 625 SLATERS LANE, FOURTH FLOOR, ALEXANDRIA, VA, 22314, US

(21) Appl. No.: 11/071,162

(22) Filed: Mar. 4, 2005

(51) Int. Cl. B29C 45/16

(52) U.S. Cl. 425/585

(57) ABSTRACT

A feeding mechanism for injection-molding machine includes an injection machine frame, which is provided at a middle section with a feeding pipe defining a chamber for receiving heated and softened plastic material therein, such that the received plastic material for injection molding could be pushed forward under an axial pressure from a rear section of the chamber, and in front of the chamber with an injection channel, such that the plastic material in the chamber for injection is injected via a front open end of the injection channel into a mold. The feeding mechanism is characterized in that the feeding pipe is provided at an upper side with a plurality of feeding inlets, so that a plurality of material tanks having differently colored plastic materials stored therein are separately connected thereto for forming an injection-molded product containing different colors through only one injection.

### FIELD OF THE INVENTION

The present invention relates to an injection-molding machine, and more particularly to a feeding mechanism for injection-molding machine that includes multiple material tanks for receiving differently colored plastic materials therein to enable molding of a finished product showing multiple colors or patterns through only one injection.

### BACKGROUND OF THE INVENTION

A plastic injection-molding machine has been employed in a wide range of applications and plays an important role in the early stage of industrial upgrade for making various kinds of general living and industrial products, such as silicone products, PET containers, auto parts, cosmetics containers, domestic containers, precision gears, etc. The plastic injection-molding machine would also keep playing an important role in many advanced technological fields to produce, for example, semiconductor components, computers, optical lenses, liquid crystal displays, IC cards, electronic materials and parts, and elements for biochemical, medical, micro-mechano-electronic, information industrial, photoelectric, and precision measuring purposes. However, the application of the plastic injection-molding machine to these advanced industries relies on further upgrade in the micro-injection-molding technique.

In view that the injection-molding machine plays an important role in many industrial fields, a lot of manufacturers have engaged in the improvement thereof. As an example, Taiwanese Patent Publication No. 479614 discloses an injection-molding machine, which includes an injection machine frame. The injection machine frame is provided at a middle section with a feeding mechanism, which defines a chamber for receiving heated and softened plastic material therein for injection, and includes an injection channel in front of the chamber for the plastic material received in the chamber to be injected via a front open end of the injection channel into a pre-mounted mold. The feeding mechanism is characterized in that an axial front end of the injection channel is radially sealed to sustain a forward pressure from the chamber, so that the softened plastic material automatically axially moves from the chamber through the injection channel; and that a plurality of shunting paths and converging paths are axially, alternately and continuously provided in the injection channel for the softened plastic material to automatically produce divergent flows that converge, compress and rub against one another, and become mixed when they pass through the injection channel. Therefore, the conventional injection-molding machine can achieve the molding effect through axial light power push and precision control of micro injection without a spiral feeder.

FIG. 1 shows a conventional injection-molding machine that typically has only one single material tank and can therefore form a finished product showing only one color. When it is desired to show more than one color on the molded product, additional coloring process is required after the product is molded. Or, a whole roll of plastic film printed with desired patterns is mounted on the injection-molding machine and pulled along with the operation of the injection-molding machine, so that the printed plastic film is aligned with the mold cavity before molding. Most of the molded products of bowls, dishes, plates, etc. must be processed in this manner to show patterns or designs on their outer surfaces. Since this manner of injection molding multi-colored products is complicate and troublesome, and requires high labor and time cost, it is tried by the inventor to develop an improved feeding mechanism for injection-molding machine to enable molding of a finished product showing multiple colors or patterns through only one injection.

### SUMMARY OF THE INVENTION

A primary object of the present invention is to provide a feeding mechanism for injection-molding machine that enables molding of a finished product showing multiple colors or patterns through only one injection without the need of any subsequent coloring or printing process.

To achieve the above and other objects, the feeding mechanism for injection-molding machine according to the present invention includes an injection machine frame having a feeding pipe provided at a middle section thereof to define a chamber for receiving heated and softened plastic material therein, such that the received plastic material for injection molding could be pushed forward under an axial pressure from a rear section of the chamber, and an injection channel located in front of the chamber defined by the feeding pipe, such that the plastic material for injection is injected via a front open end of the injection channel into a mold. The feeding mechanism is characterized in that the feeding pipe is provided at an upper side with a plurality of feeding inlets, so that a plurality of material tanks having differently colored plastic materials stored therein are separately connected thereto for forming an injection-molded product containing different colors through only one injection.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a plan view of a conventional injection-molding machine;

FIG. 2 is a plan view of an injection-molding machine according to the present invention;

FIG. 3A schematically shows a first pattern shown by multiple colored plastic materials injected at the same time;

FIG. 3B schematically shows a second pattern shown by multiple colored plastic materials injected at the same time;

FIG. 4 illustrates a finished product of bowl showing different colors and patterns being injection-molded using the present invention; and

FIG. 5 illustrates a finished product of fluorescent flowerpot being injection-molded using the present invention.

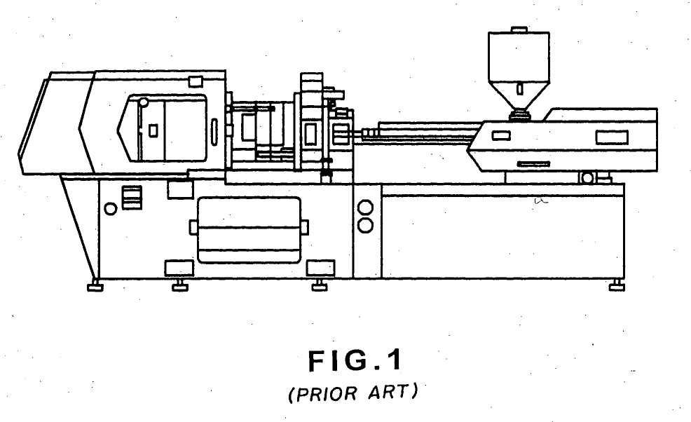

### DETAILED DESCRIPTION OF THE PREFERRED EMBODIMENTS

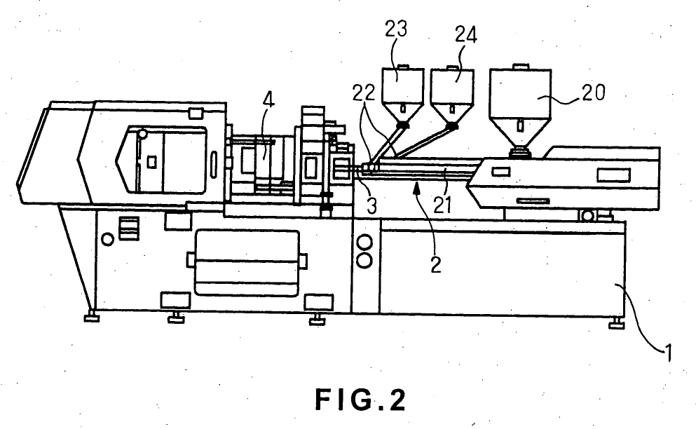

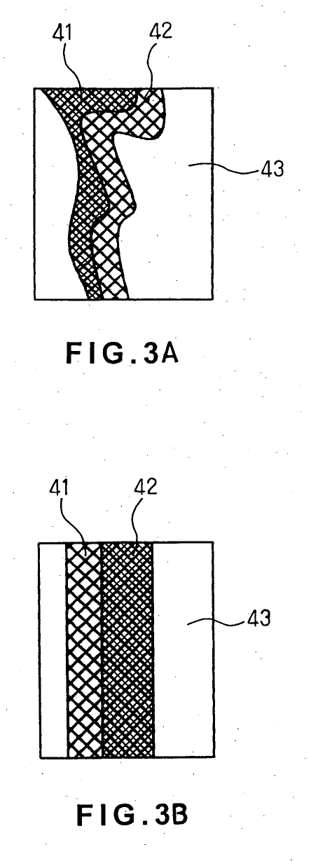

Please refer to FIG. 2 that is a plan view of an injection-molding machine having a feeding mechanism according to the present invention. As shown, the feeding mechanism for the injection-molding machine includes an injection machine frame 1, a middle section of which is provided with a feeding pipe 2. The feeding pipe 2 defines a chamber 21 for receiving heated and softened plastic material therein, such that the received plastic material for injection molding could be pushed forward under an axial pressure from a rear section of the chamber 21. An injection channel 3 is provided in front of the chamber 21, such that the plastic material for injection is injected via a front open end of the injection channel 3 into a pre-mounted mold 4. The feeding mechanism of the present invention is characterized in that the feeding pipe 2 is provided at an upper side with a plurality of feeding inlets 22, so that a plurality of material tanks 23 having differently colored plastic materials 41, 42, 43 stored therein (see FIGS. 3A and 3B) are separately connected thereto for forming an injection-molded product containing different colors through only one injection.

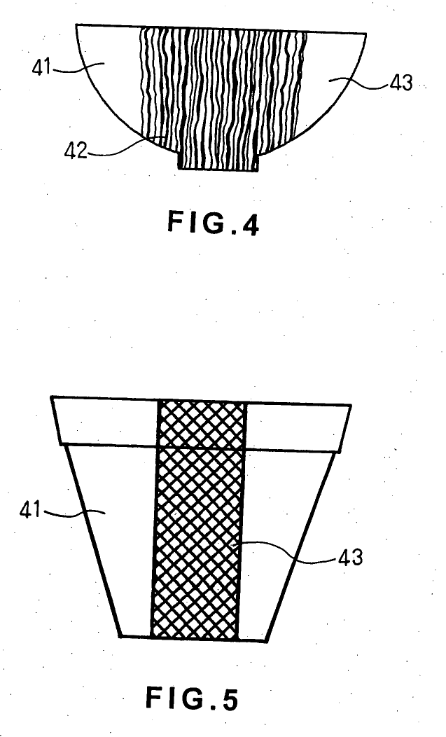

The feeding inlets 22 and the material tanks 23 connected thereto are spaced along a top of the chamber 21 and the injection channel 3. In a most preferred embodiment of the present invention, the feeding inlets 22 and the material tanks 23 other than a main material tank 20 provided above a rear end of the feeding pipe 2 are located on the injection channel 3 at a distance about 1 cm to 9 cm away from a material inlet on the mold 4. It is noted the distance between the injection channel 3 and the material inlet on the mold 4 is determined depending on actual need. With these arrangements, plastic materials of different colors may be supplied into the main feeding pipe 2 via the feeding inlets 22 to melt and disperse in but not fully blend with the plastic material from the main material tank 20. The differently colored plastic materials from the material tanks 23 move forward along with the main material from the main material tank 20 to form regular or irregular color patterns and designs on a product injection-molded using the main material, as shown in FIGS. 3A and 3B. It is also noted that the colors naturally formed on the finished injection-molded product in this manner using the present invention is not subject to color fading, as shown in FIG. 4.

In an embodiment of the present invention, an additional set of feeding inlet 22 and material tank 24 may be provided on the injection machine frame 1 for feeding a fluorescent plastic material, so that a finished product injection-molded using the present invention is fluorescent without the need of any additional coloring process. This arrangement is particularly suitable for forming, for example, flowerpots to increase the brightness thereof. The fluorescent flowerpot could be conveniently located in the dark, and may be used as a night warning means on safety islands on roads to avoid collisions.

The above-mentioned mixed plastic materials may be supplied via one single or multiple feeding pipes, and may be used in a wide range of applications, including housings and panels for computers, electric and electronic appliances, toys, electric lamp switch cover plates, plastic cloth, etc. With the present invention, all injection-molded products have beautiful colors, shapes, and patterns when they are finished, and no other printing or laminating process in the conventional injection molding technique is needed. Therefore, the injection molding could be performed at largely reduced cost. Since the finished products being injection-molded using the present invention present two or more colors that are either separated from or mixed with one another to show various changes, or adapted to reflect external images or even form irregular or regular designs, marks, words, lines, or any combination thereof, the products are more beautiful and valuable than those formed using the conventional injection-molding machine.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A feeding mechanism for injection-molding machine comprising an injection machine frame; said injection machine frame being provided at a middle section with a feeding pipe defining a chamber for receiving heated and softened plastic material therein, such that said received plastic material for injection molding could be pushed forward under an axial pressure from a rear section of said chamber, and in front of said chamber defined by said feeding pipe with an injection channel, such that said plastic material received in said chamber for injection is injected via a front open end of said injection channel into a mold; said feeding mechanism being characterized in that said feeding pipe is provided at an upper side with a plurality of feeding inlets, so that a plurality of material tanks having differently colored plastic materials stored therein are separately connected thereto for forming an injection-molded product containing different colors through only one injection.

2. The feeding mechanism for injection-molding machine as claimed in claim 1, wherein said a plurality of feeding inlets and said a plurality of material tanks connected to said feeding inlets are spaced along a top of said chamber and said injection channel.

3. The feeding mechanism for injection-molding machine as claimed in claim 1, wherein said injection machine frame is further provided with one set of material tank and feeding inlet for receiving and feeding a fluorescent plastic material into said feeding pipe.
